(19) United States
(12) Patent Application Publication
(10) Pub. No.: US 2020/0177756 A1
(43) Pub. Date: Jun. 4, 2020

(54) INFORMATION PROCESSING APPARATUS CAPABLE OF PREVENTING UNINTENDED PROCESSING FROM BEING PERFORMED DUE TO REMAINING ELECTRIC CHARGE, CONTROL METHOD THEREFOR, AND STORAGE MEDIUM

(71) Applicant: CANON KABUSHIKI KAISHA, Tokyo (JP)

(72) Inventor: Ryotaro Okuzono, Toride-shi (JP)

(21) Appl. No.: 16/674,048

(22) Filed: Nov. 5, 2019

(30) Foreign Application Priority Data
Dec. 3, 2018 (JP) 2018-226634

(51) Int. Cl. H04N 1/00; H04N 1/32

(52) U.S. Cl. CPC H04N 1/00899; H04N 1/32694; H04N 1/00893; H04N 1/00904

(57) ABSTRACT

An information processing apparatus which is capable of preventing unintended power abnormality data arising from remaining electronic charge being written into a nonvolatile memory. The nonvolatile memory stores information indicating that an output voltage of the power supply device has become equal to or lower than a threshold value. Power is controlled to be supplied from a power supply device to a processor in accordance with an operation on a power switch received in a state where no power was supplied to the processor, and power is controlled to be supplied from the power supply device to the processor in accordance with the information stored in the nonvolatile memory. Writing of the information into the nonvolatile memory is enabled in accordance with input of a predetermined signal output from the processor to which the power is supplied.

### BACKGROUND OF THE INVENTION

### Field of the Invention

The present invention relates to an information processing apparatus and a control method therefor which are capable of preventing unintended processing from being performed due to remaining electric charge, as well as a storage medium.

### Description of the Related Art

An MFP which is an electronic apparatus carrying out such processes as a copying process, a printing process, and a faxing process is known. The MFP has a power switch, and in response to operation performed on the power switch by a user, the MFP is controlled to be started and stopped.

When the supply of power to the MFP is suspended due to occurrence of an abnormal power state such as a power outage while the MFP is running, the MFP stops operating to become incapable of carrying out the processes. To prevent the faxing process or the like from being delayed, the MFP needs to be started immediately after the abnormal power state is resolved in the MFP. In a case where the power switch of the MFP physically keeps a state of indicating that the MFP is running or at a standstill, like as a seesaw switch, the MFP is able to determine whether or not the MFP was running immediately before occurrence of the abnormal power state based on a state of the power switch. The MFP determines whether or not to carry out a starting process for the MFP based on a result of the determination. On the other hand, in a case where the power switch of the MFP does not physically keep a state of indicating that the MFP is running or at a standstill, like as a tact switch, the MFP is not able to determine whether or not the MFP was running immediately before occurrence of the abnormal power state based on a state of the power switch. As a result, even if the MFP was running immediately before occurrence of the abnormal power state, the MFP is not able to carry out the starting process after the abnormal power state is resolved.

To cope with this problem, the MFP holds power abnormality data indicating the abnormal power state in a nonvolatile memory when the output voltage of a power supply has become equal to or lower than a threshold value and determines whether or not to carry out the starting process based on the power abnormality data when the abnormal power state is resolved (see, for example, Japanese Laid-Open Patent Publication (Kokai) No. 2017-188791).

In the conventional MFP, however, there may be cases where unintended power abnormality data is held in the nonvolatile memory. Here, even if an AC cable is removed from an outlet after the power is turned off by the power switch, electric charge remains in a smoothing capacitor provided in, for example, a power supply unit of the MFP. If the user turns on the power switch by mistake in this state, the MFP starts to carry out the starting process using the electric charge remaining in the smoothing capacitor. In the MFP, however, since the supply of power from the outlet to the MFP has been stopped, the electric charge remaining in the smoothing capacitor is immediately consumed, causing the output voltage being monitored to drop and resulting in unintended power abnormality data indicating the abnormal power state being held in the nonvolatile memory. If the AC cable is inserted into the outlet while the power abnormality data is held in the nonvolatile memory, the MFP starts to carry out the starting process, which is not intended, based on the power abnormality data.

### SUMMARY OF THE INVENTION

The present invention provides an information processing apparatus and a control method therefor which are capable of preventing unintended power abnormality data arising from remaining electronic charge from being written, as well as a storage medium.

Accordingly, the present invention provides an information processing apparatus comprising a processor, a power supply device configured to supply power to at least the processor, a nonvolatile memory configured to store information indicating that an output voltage of the power supply device has become equal to or lower than a threshold value, a power controller configured to control power such that power is supplied from the power supply device to the processor in accordance with an operation on a power switch received in a state where no power was supplied to the processor, and control power such that power is supplied from the power supply device to the processor in accordance with the information stored in the nonvolatile memory, and a memory controller configured to enable writing of the information into the nonvolatile memory in accordance with input of a predetermined signal output from the processor to which the power is supplied.

According to the present invention, unintended power abnormality data arising from remaining electronic charge is prevented from being written.

Further features of the present invention will become apparent from the following description of exemplary embodiments with reference to the attached drawings.

### BRIEF DESCRIPTION OF THE DRAWINGS

FIG. 1 is a block diagram schematically showing an arrangement of an MFP which is an electronic apparatus (information processing apparatus) according to an embodiment of the present invention.

FIG. 2 is a block diagram schematically showing an arrangement of a main controller unit in FIG. 1.

FIG. 3 is a block diagram schematically showing an arrangement of a power control unit in FIG. 2.

FIG. 4 is a flowchart showing the procedure of a power supply stop process which is carried out by the power control unit in FIG. 2.

FIGS. 5A and 5B are timing charts showing state transitions of respective signals when the MFP shifts from a running state to a stopped state in the power supply stop process in FIG. 4.

FIG. 6 is a view useful in explaining voltage drop of the output voltage of a power supply unit in a case where a power switch is depressed while electric charge remains in a power source unit.

FIG. 7 is a flowchart showing the procedure of a start control process which is carried out by the power control unit in FIG. 2.

FIGS. 8A and 8B are timing charts showing state transitions of respective signals when the MFP shifts from the stopped state to the running state in the start control process in FIG. 7.

FIG. 9 is a block diagram schematically showing an arrangement of a variation of the power control unit in FIG. 2.

FIG. 10 is a flowchart showing the procedure of a variation of the start control process in FIG. 7.

FIGS. 11A and 11B are timing charts showing state transitions of respective signals when the MFP shifts from the stopped state to the running state in the start control process in FIG. 10.

### DESCRIPTION OF THE EMBODIMENTS

The present invention will now be described in detail below with reference to the accompanying drawings showing an embodiment thereof. It should be noted that in the following description of the present embodiment, the present invention is applied to an MFP which is an electronic apparatus (information processing apparatus), but the present invention is not limited to the MFP. For example, the present invention may be applied to other apparatuses such as a printer, a scanner, and a PC, to which power is externally supplied.

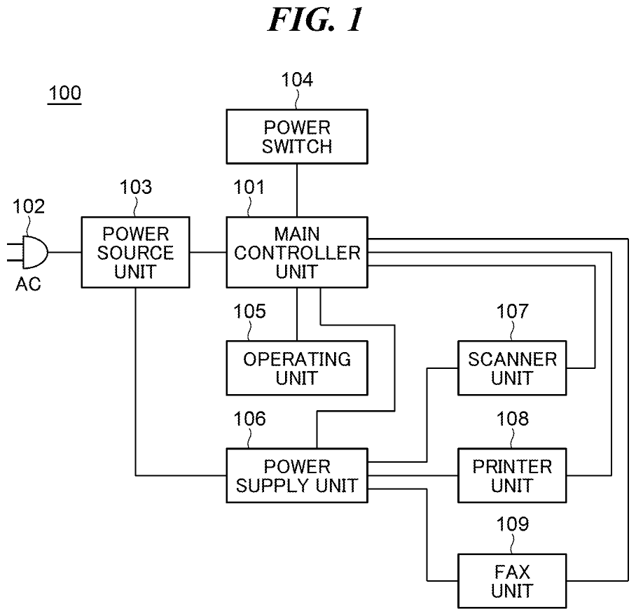

FIG. 1 is a block diagram schematically showing an arrangement of the MFP 100 which is an electronic apparatus (information processing apparatus) according to the embodiment of the present invention. Referring to FIG. 1, the MFP 100 has a main controller unit 101, an AC plug 102, a power source unit 103 (power supply device), a power switch 104, an operating unit 105, and a power supply unit 106. The MFP 100 also has a scanner unit 107, a printer unit 108, and a fax unit 109. The main controller unit 101 is connected to the power source unit 103, the power switch 104, the operating unit 105, the power supply unit 106, the scanner unit 107, the printer unit 108, and the fax unit 109, respectively. The AC plug 102 is connected to the power source unit 103.

The MFP 100 is an image forming apparatus capable of carrying out such processes as a scanning process, a printing process, and a faxing process. The main controller unit 101 integratedly controls the entire MFP 100. The AC plug 102 is inserted into an external outlet that is a power source. AC power (alternating current power) is supplied from the external outlet to the power source unit 103 via the AC plug 102. The power source unit 103 converts the AC power supplied from the external outlet to DC power (direct current power) and supplies the DC power to the main controller unit 101 and the power supply unit 106. The power switch 104 is a switch for the user to control start and stop of the MFP 100. The power switch 104 is comprised of, for example, a push switch that does not physically holds a state in which the MFP 100 is running or stopped. When being depressed by the user, the power switch 104 notifies the main controller unit 101 of that. The operating unit 105 has a display unit and operating keys, not shown, and receives instructions to carry out the processes input by the user. The power supply unit 106 supplies power supplied from the power source unit 103 to the scanner unit 107, the printer unit 108, and the fax unit 109. The scanner unit 107 reads an original placed on an original platen, not shown, and generates image data. The printer unit 108 performs printing on a sheet based on, for example, image data generated by the scanner unit 107. The fax unit 109 carries out facsimile communications with an external apparatus (not shown) to send and receive fax data.

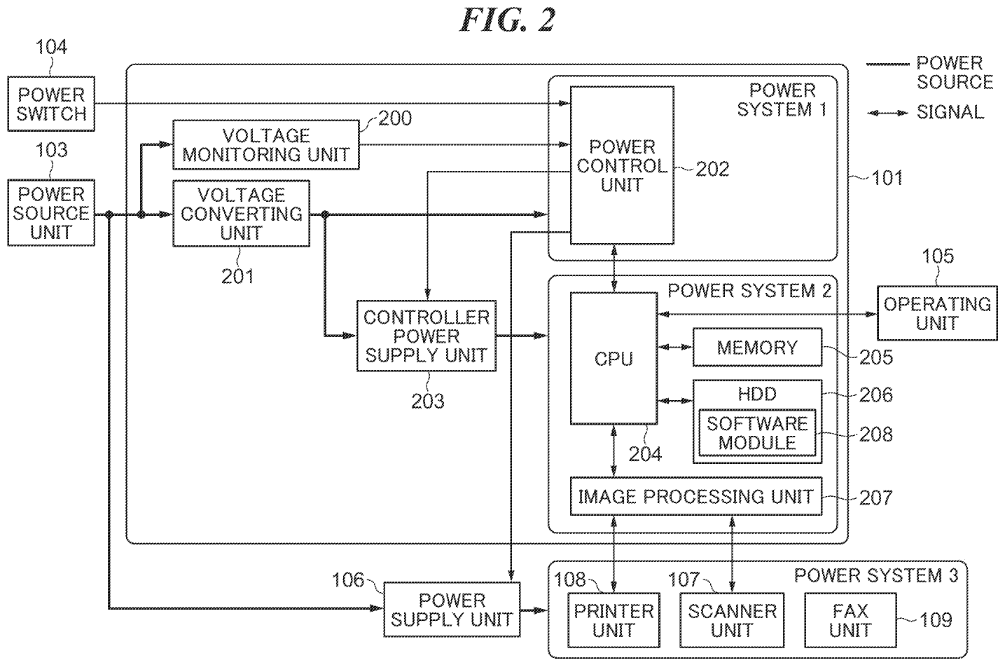

FIG. 2 is a block diagram schematically showing an arrangement of the main controller 101 in FIG. 1. Referring to FIG. 2, the main controller 101 has a voltage monitoring unit 200, a voltage converting unit 201, a power control unit 202 (a power controller), a controller power supply unit 203, a CPU 204 (processor), a memory 205, an HDD 206, and an image processing unit 207. The power control unit 202 is connected to the power switch 104, the voltage monitoring unit 200, the voltage converting unit 201, the controller power supply unit 203, the power supply unit 106, and the CPU 204, respectively. The CPU 204 is connected to the power control unit 202, the controller power supply unit 203, the operating unit 105, the memory 205, the HDD 206, and the image processing unit 207, respectively.

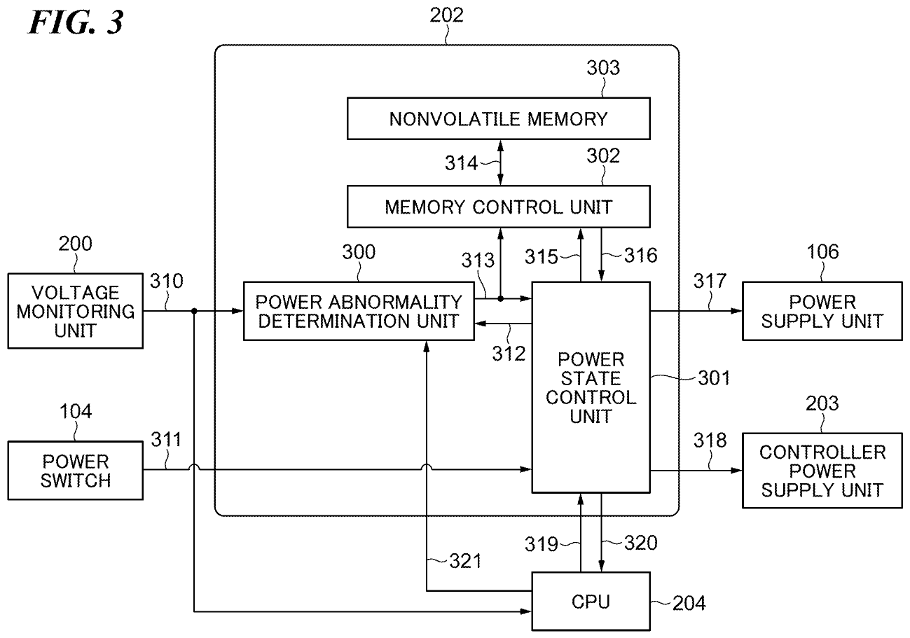

The voltage monitoring unit 200 monitors voltage values of power supplied from the power supply unit 103 and sends a voltage drop notification signal 310 in FIG. 3, which will be described later, indicating a monitoring result to the power control unit 202. The voltage converting unit 201 converts a voltage value of power supplied from the power source unit 103 into required voltage values for the power control unit 202 and the controller power supply unit 203. The voltage converting unit 201 supplies power, whose voltage value has been converted into the required voltage values, to the power control unit 202 and the controller power supply unit 203.

The power control unit 202 controls start and stop of the MFP 100. For example, in a case where the power switch 104 is depressed while the MFP 100 is running, the power control unit 202 instructs the CPU 204 to carry out a shutdown process and stop supplying power to the power supply unit 106 and the controller power supply unit 203. This brings the MFP 100 from a running state in which the MFP 100 is running, to a stopped state in which the MFP 100 is stopped. In the present embodiment, regardless of an operating state of the power switch 104, power continues to be supplied to the power control unit 202 until an abnormal power state such as a power outage or withdrawal of the AC plug 102 occurs, that is, while power is being supplied from the external outlet. In the following description, a power source system in the MFP 100 to which power continues to be supplied while power is being supplied from the external outlet regardless of an operating state of the power switch 104 will be defined as a “power source system 1”. Power source systems in the MFP 100 to which power is controlled to be supplied or not supplied depending on an operating state of the power switch 104 will be defined as “power source systems 2, 3”. The power source system 2 is supplied with power from the controller power supply unit 203. The power source system 3 is supplied with power from the power supply unit 106.

The controller power supply unit 203 supplies power converted by the voltage converting unit 201 to the CPU 204, the memory 205, the HDD 206, and the image processing unit 207 based on a supply control signal 318 in FIG. 3, which will be described later, received from the power control unit 202. The CPU 204 performs various types of control by executing programs stored in the HDD 206. The memory 205 is a volatile memory. The memory 205 is a main memory which stores, for example, data generated by the CPU 204 executing programs. The HDD 206 stores a software module 208, programs to be executed by the CPU 204, setting information on the MFP 100, and so forth. The software module 208 is used to start a starting process for the MFP 100. The image processing unit 207 performs image processing such as color space conversion on image data generated by the scanner unit 107 and outputs the image data subjected to the image processing to the printer 108.

FIG. 3 is a block diagram schematically showing an arrangement of the power control unit 202 in FIG. 2. Referring to FIG. 3, the power control unit 202 has a power abnormality determination unit 300, a power state control unit 301, a memory control unit 302 (memory controller), and a nonvolatile memory 303. It should be noted that in the following description of the present embodiment, it is assumed that the nonvolatile memory 303 is provided in the power control unit 202, but this is merely one example, and the nonvolatile memory 303 may be provided in one of the component elements of the MFP 100 other than the power control unit 202.

The power abnormality determination unit 300 performs monitoring so as to detect an abnormal power state resulting from a power outage, unintended withdrawal of the AC plug 101 by the user, or the like. Specifically, based on the voltage drop notification signal 310 received from the voltage monitoring unit 200 and a power state notification signal 312, which will be described later, received from the power state control unit 301, the power abnormality determination unit 300 determines whether or not an abnormal power state has occurred. The power abnormality determination unit 300 also sends a power abnormality signal 313, which indicates a result of the determination, to the power state control unit 301 and the memory control unit 302. The power abnormality determination unit 300 also selectively performs monitoring for an abnormal power state based on a power abnormality determination control signal 321 received from the CPU 204.

The power state control unit 301 manages whether or not the MFP 100 is in a running state based on a power switch state signal 311 received from the power switch 104. The power switch state signal 311 is a signal indicating whether or not the power switch 104 has been depressed. The power state control unit 301 sends the power state notification signal 312, which indicates whether or not the MFP 100 is in the running state, to the power abnormality determination unit 300. The power state control unit 301 controls the supply of power of the power systems 2, 3. Specifically, the power state control unit 301 sends supply control signals 317, 318, which give an instruction to start or stop the supply of power, to the power supply unit 106 and the controller power supply unit 203, respectively. The power state control unit 301 also sends a shutdown instruction signal 320, which gives an instruction to carry out a shutdown process, to the CPU 204. When the supply of power from the external outlet to the MFP 100 is started, the power state control unit 301 sends a memory readout notification signal 315, which give an instruction to read out data stored in the nonvolatile memory 303, to the memory control unit 302.

The memory control unit 302 sends a memory control signal 314 to the nonvolatile memory 303. The memory control signal 314 is a control signal for reading and writing data from and into the nonvolatile memory 303. For example, upon detecting occurrence of an abnormal power state based on the power abnormality signal 313 received from the power abnormality determination unit 300, the memory control unit 302 writes power abnormality data, which indicates occurrence of the abnormal power state, into the nonvolatile memory 303. When reading the power abnormality data from the nonvolatile memory 303, the memory control unit 302 sends a power abnormality determination notification signal 316 indicating that to the power state control unit 301. The nonvolatile memory 303 is a storage medium capable of holding data even after the supply of power to the MFP 100 is stopped. A limit to the number of times that data can be written is set for the nonvolatile memory 303.

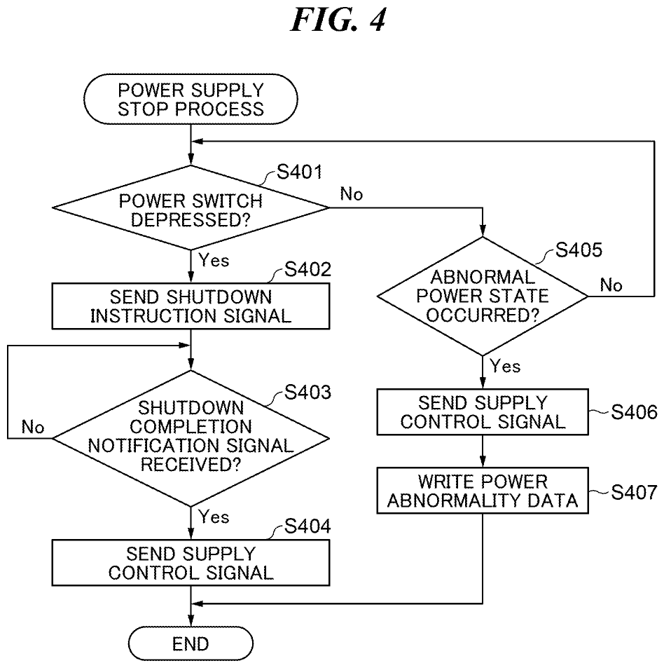

FIG. 4 is a flowchart showing the procedure of a power supply stop process which is carried out by the power control unit 202 in FIG. 2. The process in FIG. 4 is based on the assumption that the MFP 100 is in the running state, and power is being supplied to the power systems 1 to 3.

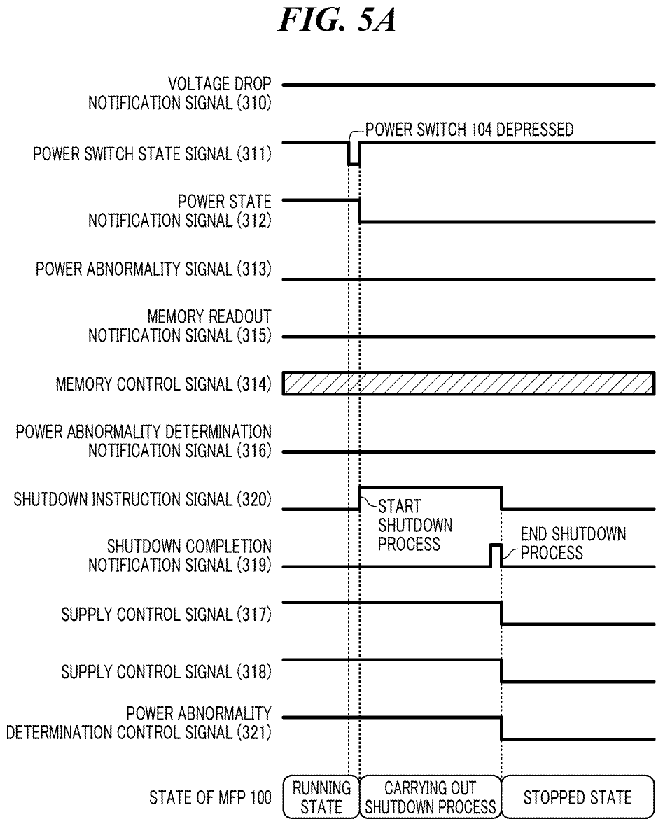

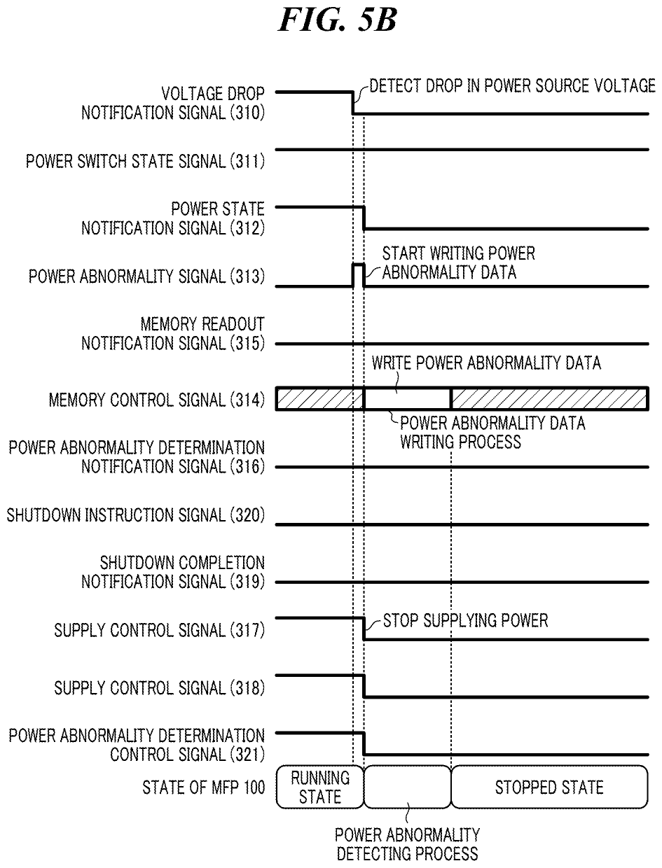

Referring to FIG. 4, first, based on the received power switch state signal 311, the power control unit 202 determines whether or not the power switch 104 has been depressed (step S401). FIG. 5A is a timing chart showing state transitions of respective signals when the MFP 100 shifts from a running state to a stopped state in response to depression of the power switch 104. In the MFP 100, the power switch state signal 311 at a high level is output in the running state, and when the power switch 104 is depressed, the power switch state signal 311 shifts from the high level to a low level (see, for example, FIG. 5A). In the step S401, in a case where the power switch state signal 311 shifts from the high level to the low level, the power control unit 202 determines that the power switch 104 has been depressed. On the other hand, when the power switch state signal 311 is kept at the high level, the power control unit 202 determines that the power switch 104 has not been depressed.

As a result of the determination in the step S401, when the power switch 104 has been depressed, the power control unit 202 sends the shutdown instruction signal 320 to the CPU 204 (step S402). Upon receiving the shutdown instruction signal 320, the CPU 204 starts the shutdown process. Upon completing the shutdown process, the CPU 204 sends a shutdown completion notification signal 319 indicating that to the power control unit 202.

Upon receiving the shutdown completion notification signal 319 from the CPU 204 (YES in step S403), the power control unit 202 carries out a process in step S404. In the step S404, the power control unit 202 sends the supply control signals 317, 318 at a low level, which give an instruction to stop supplying power, to the power supply unit 106 and the controller power supply unit 203, respectively. As a result, the supply of power to the power systems 2 and 3 among the power systems 1 to 3 is stopped, which brings the MFP 100 from the running state to the stopped state. After that, the power control unit 202 ends the present process.

As a result of the determination in the step S401, in a case where the power switch 104 has not been depressed, the power control unit 202 determines whether or not an abnormal power state has occurred based on the power abnormality signal 313 (step S405). FIG. 5B is a timing chart showing state transitions of respective signals when the MFP 100 shifts from the running state to the stopped state in response to occurrence of an abnormal power state. In a case where power is being supplied to the MFP 100 from the external outlet, the power abnormality determination unit 300 outputs the power abnormality signal 313 at a low level which indicates a normal power state. On the other hand, upon detecting all of the following: an abnormal power state monitoring having been enabled based on the power state notification signal 312; the MFP 100 being in a running state based on the power state notification signal 312; and a voltage value of power of the power source unit 103 being equal to or lower than the threshold value based on the voltage drop notification signal 310, the power abnormality determination unit 300 outputs the power abnormality signal 313 at a high level which indicates that an abnormal power state has occurred. Namely, in the present embodiment, as long as the MFP 100 is in the stopped state, the power abnormality signal 313 at the high level is not output even if a voltage value of power from the power source unit 103 is equal to or lower than the threshold value. Moreover, unless abnormal power state monitoring is enabled, the power abnormality signal 313 at the high level is not output even if a voltage value of power from the power source unit 103 is equal to or lower than the threshold value.

In step S405, in a case where the power abnormality signal 313 is at the high level, the power control unit 202 determines that an abnormal power state has occurred. On the other hand, in a case where the power abnormality signal 313 is at the low level, the power control unit 202 determines that no abnormal power state has occurred.

As a result of the determination in the step S405, in a case where the power control unit 202 determines that no abnormal power state has occurred, the process returns to the step S401. As a result of the determination in the step S405, in a case where an abnormal power state has occurred, the power control unit 202 sends the supply control signals 317, 318 at the low level, which give an instruction to stop supplying power, to the power supply unit 106 and the controller power supply unit 203, respectively (step S406). When the supply of power by the controller power supply unit 203 is stopped, the CPU 204 turns into a power off state, and the power abnormality determination control signal 321 shifts to the low level which indicates that monitoring for an abnormal power state has been disabled.

Then, the power control unit 202 writes power abnormality data into the nonvolatile memory 303 (step S407). Namely, in the present embodiment, power abnormality data is written into the nonvolatile memory 303 in a case where the MFP 100 is in a running state, monitoring for an abnormal power state has been enabled, and the voltage value of power of the power source unit 103 is equal to or lower than the threshold value. Here, power abnormality data is information indicating that the output voltage of the power source unit 103 has become equal to or lower than the threshold value. On the other hand, no power abnormality data is written into the nonvolatile memory 303 at least while the MFP 100 is shifting from the stopped state to the running state, and more specifically, until an instruction to start the MFP 100 is received after an instruction to stop the MFP 100 is received. After that, the power control unit 202 ends the present process. In the MFP 100, when an abnormal power state occurs, the supply of power to the power source systems 2, 3 is stopped by the process in FIG. 4, and then the supply of power to the power source system 1, that is, the supply of power to the power control unit 202 is also stopped due to the supply of power from the external outlet being stopped.

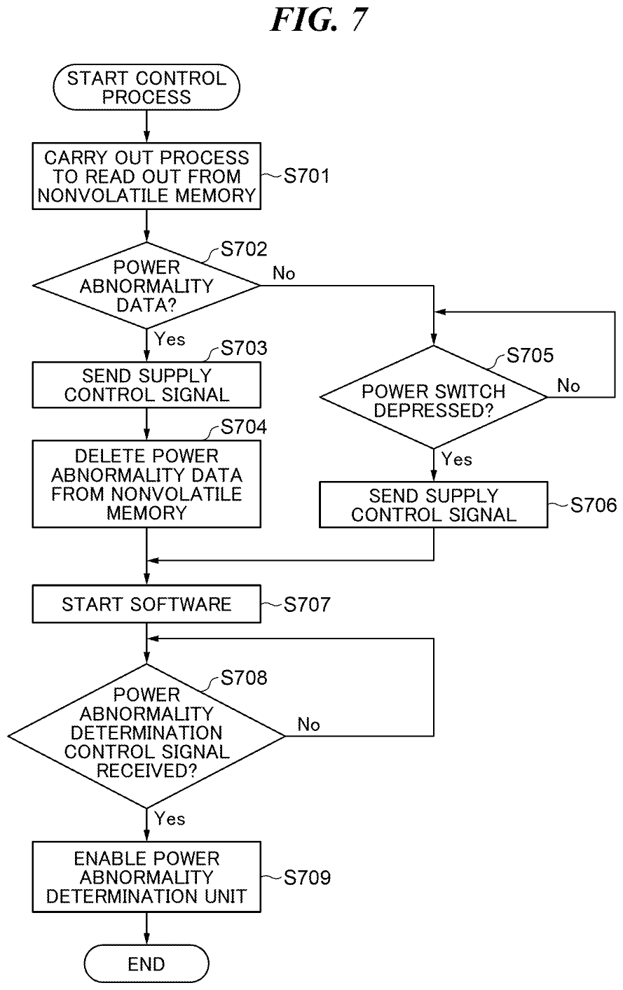

A description will now be given of a process that is carried out when an abnormal power state has been resolved. When the abnormal power state has been resolved, the supply of power to the MFP 100 from the external outlet is resumed, and in the MFP 100, the supply of power to the power control unit 202 is started. The power control unit 202 supplied with power carries out a start control process in FIG. 7, which will be described later. In the present embodiment, even when the supply of power to the power control unit 202 has been started, the power to the CPU 204 is in a power off state, and the power abnormality determination control signal 321 is kept at the low level because the supply of power from the controller power supply unit 203 is still stopped. Namely, in the MFP 100, at the time when the supply of power is resumed after the abnormal power state has been resolved, monitoring for an abnormal power state is still disabled.

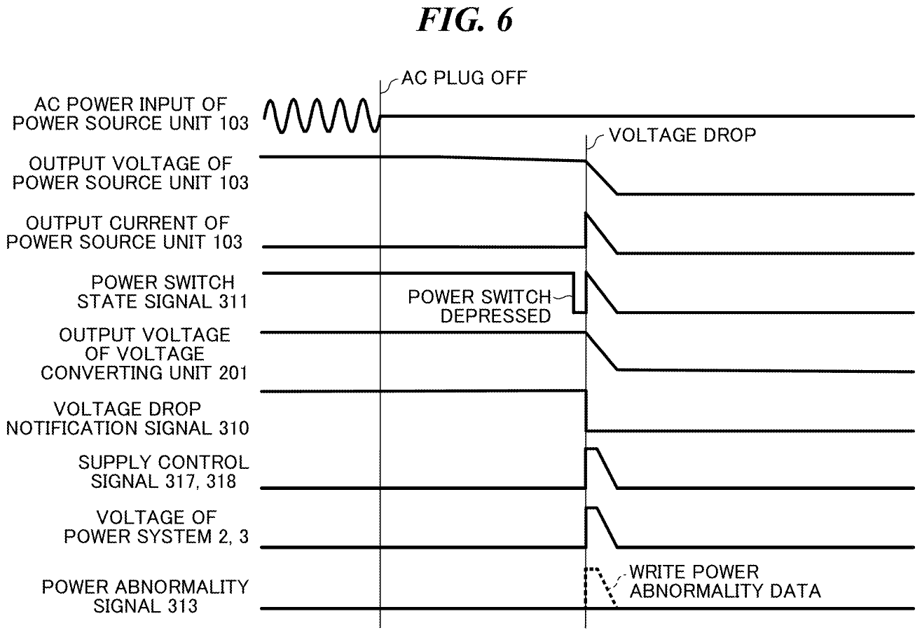

In the conventional MFP, in a case where, for example, an abnormal power state such as withdrawal of the AC plug from the external outlet has occurred, the supply of power to the power systems 1 to 3 is stopped as described above, whereas electric charge remains in a smoothing capacitor provided in the power source unit as a measure against a temporary blackout. For example, if the user depresses the power switch by mistake in a state where electric charge remains, the conventional MFP starts the starting process using the remaining electric charge. However, in the conventional MFP 100, since the supply of power from the external outlet has been stopped, the electric charge remaining in the smoothing capacitor is immediately consumed, causing the output voltage of the power source unit to drop as shown in FIG. 6. For example, when about 100 ms has elapsed since the starting process was started, the output voltage of the power source unit is equal to or lower than the above mentioned threshold value. For this reason, the conventional MFP has a problem that unintended power abnormality data indicating occurrence of an abnormal power state is held in the nonvolatile memory.

To address this problem, in the present embodiment, monitoring for an abnormal power state is started, after the CPU 204 is started and the software module 208 to be executed by the CPU 204 is started as well.

FIG. 7 is a flowchart showing the procedure of the start control process which is carried out by the power control unit 202 in FIG. 2.

Referring to FIG. 7, first, the power control unit 202 carries out a process to read out data stored in the nonvolatile memory 303 (step S701). Next, the power control unit 202 determines whether or not the data that has been read out is the power abnormality data (step S702).

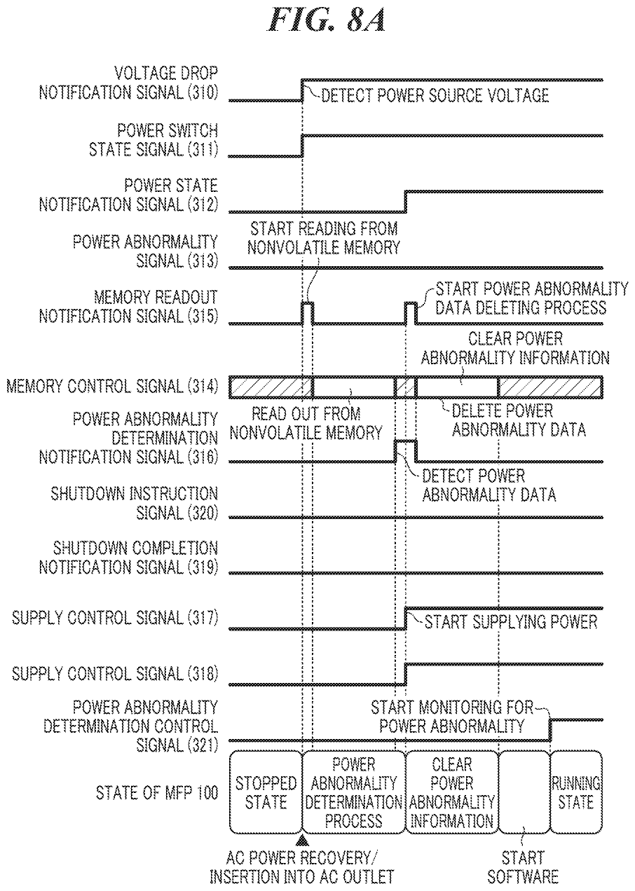

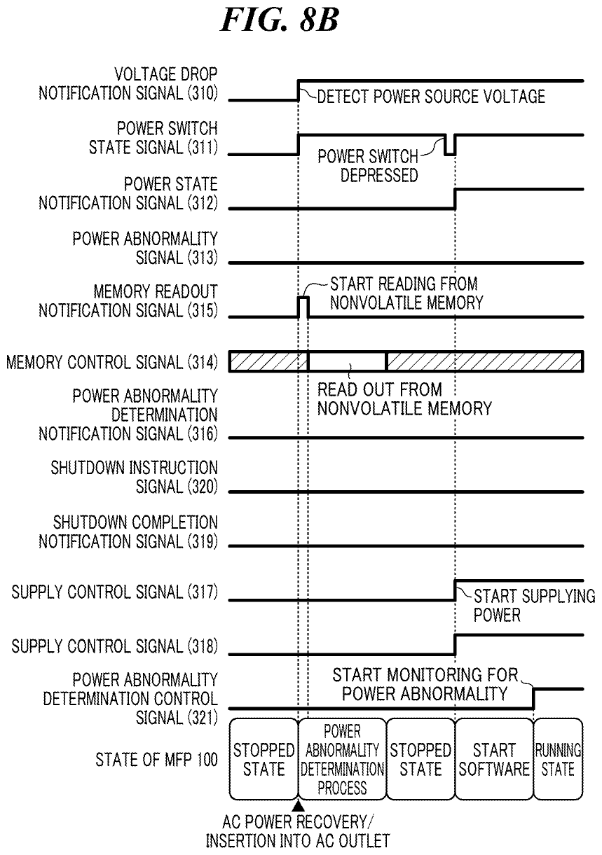

As a result of the determination in the step S702, when the data that has been read out is the power abnormality data, the power control unit 202 carries out a process in step S703. FIG. 8A is a timing chart showing state transitions of respective signals when the MFP 100 reads out the power abnormality data and shifts from the stopped state to the running state. In the step S703, the power control unit 202 sends the supply control signals 317, 318 at a high level, which give an instruction to start supplying power, to the power supply unit 106 and the controller power supply unit 203, respectively as shown in FIG. 8A. As a result, power is supplied to the power systems 2, 3. Namely, in the present embodiment, when the abnormal power state, which had occurred in a running state of the MFP 100, has been resolved and the supply of power to the MFP 100 from the external outlet has been resumed, the MFP 100 shifts from the stopped state to the running state even if the user does not depress the power switch 104. Then, the power control unit 202 deletes the power abnormality data from the nonvolatile memory 303 (step S704) and carries out processes in step S707 and the subsequent steps, which will be described later.

As a result of the determination in the step S702, in a case where the data that has been read out is not the power abnormality data, the power control unit 202 determines whether or not the power switch 104 has been depressed based on the power switch state signal 311 (step S705). When the power switch 104 has been depressed (YES in the step S705), the power control unit 202 carries out a process in step S706. FIG. 8B is a timing chart showing state transitions of respective signals when the MFP 100 shifts from the stopped state to the running state in response to the depression of the power switch 104. In the step S706, the power control unit 202 sends the supply control signals 317, 318 at a high level, which give an instruction to start supplying power, to the power supply unit 106 and the controller power supply unit 203, respectively as shown in FIG. 8B. As a result, power is supplied to devices belonging to the power systems 2, 3, for example, the CPU 204 and the HDD 206, and the CPU 204 and the HDD 206 are started.

Then, the power control unit 202 starts the software module 208 which is to be executed by the CPU 204 for starting the starting process for the MFP 100 (step S707). After starting the software module 208, the CPU 204 checks a state of the voltage drop notification signal 310 and sends the power abnormality determination control signal 321. Upon receiving the power abnormality determination control signal 321 (YES in step S708), the power control unit 202 enables the power abnormality determination unit 300 (step S709) and starts monitoring for an abnormal power state. Namely, in the present embodiment, when the power switch 104 is depressed, the MFP 100 does not immediately start monitoring for an abnormal power state, but after the CPU 204 is started and the software module 208 is also started, the MFP 100 starts monitoring for an abnormal power state. A time period required to complete the starting of the CPU 204 and also complete the starting of the software module 208 is longer than, for example, twice as long as a time period that elapses until occurrence of an abnormal power state is detected after the starting process using remaining electric charge in a stopped state of the MFP 100. For this reason, even if the user depresses the power switch 104 by mistake in a state where the MFP 100 is in the stopped state and electric charge remains, a drop in the voltage of the power source unit 103 is not detected, and therefore unintended power abnormality data indicating a voltage drop is not written into the nonvolatile memory 303. After that, the power control unit 202 ends the present process.

According to the embodiment described above, after the CPU 204 is started and the software module 208 is also started, monitoring an abnormal power state is started. This prevents a drop in the voltage of the power source unit 103 from being detected when the user depresses the power switch 104 by mistake in the state where the MFP 100 is in a stopped state and electric charge still remains. As a result, unintended power abnormality data arising from remaining electric charge is prevented from being written into the nonvolatile memory 303.

Moreover, according to the embodiment described above, power abnormality data is not written into the nonvolatile memory 303 until an instruction to start the MFP 100 is received after an instruction to stop the MFP 100 is received. This reliably prevents unintended power abnormality data arising from electric charge which remains in the power source unit 103, when the MFP 100 is in a stopped state, from being written into the nonvolatile memory 303.

Furthermore, according to the embodiment described above, the power switch 104 is a switch that does not physically hold a state of indicating that the MFP 100 is running or at a standstill. Thus, in an apparatus equipped with the power switch 104 that does not physically hold a state of indicating the running state or the stopped state, unintended power abnormality data arising from remaining electric charge is prevented from being written into the nonvolatile memory 303.

Although the present invention has been described by way of the embodiment, the present invention should not be limited to the embodiment described above. For example, monitoring for an abnormal power state may be started after a predetermined time period has elapsed since the starting process was started.

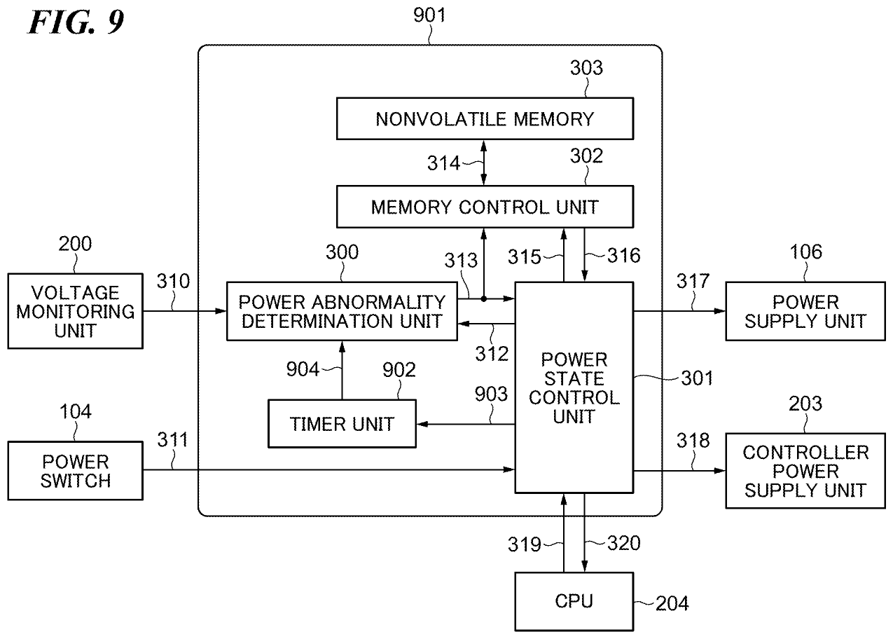

FIG. 9 is a block diagram schematically showing an arrangement of a variation of the power control unit 202 in FIG. 2. Referring to FIG. 9, the power control unit 901 has a timer unit 902 as well as the power abnormality determination unit 300, the power state control unit 301, the memory control unit 302, and the nonvolatile memory 303 in FIG. 3.

The timer unit 902 starts measuring elapsed time based on a timer unit control signal 903 received from the power state control unit 301. When a predetermined time period set in advance has elapsed since the measurement was started, the timer unit 902 sends a count-up signal 904 indicating that to the power abnormality determination unit 300. The predetermined time period is longer than 100 ms which is a time period that elapses until occurrence of an abnormal power state is detected after the starting process using remaining electric charge is started in a stopped state of the MFP 100, and the predetermined time period is for example about 200 ms to 500 ms. Based on the count-up signal 904 received from the timer unit 902, the power abnormality determination unit 300 selects whether or not to perform monitoring for an abnormal power state.

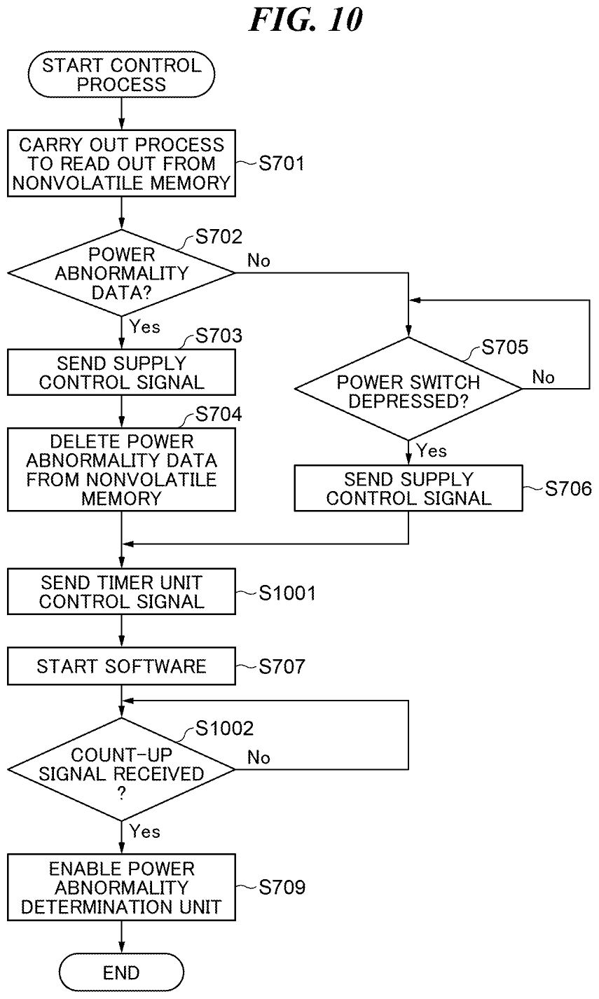

FIG. 10 is a flowchart showing the procedure of a variation of the starting control process in FIG. 7. The process in FIG. 10 is carried out by the power control unit 901 in FIG. 9.

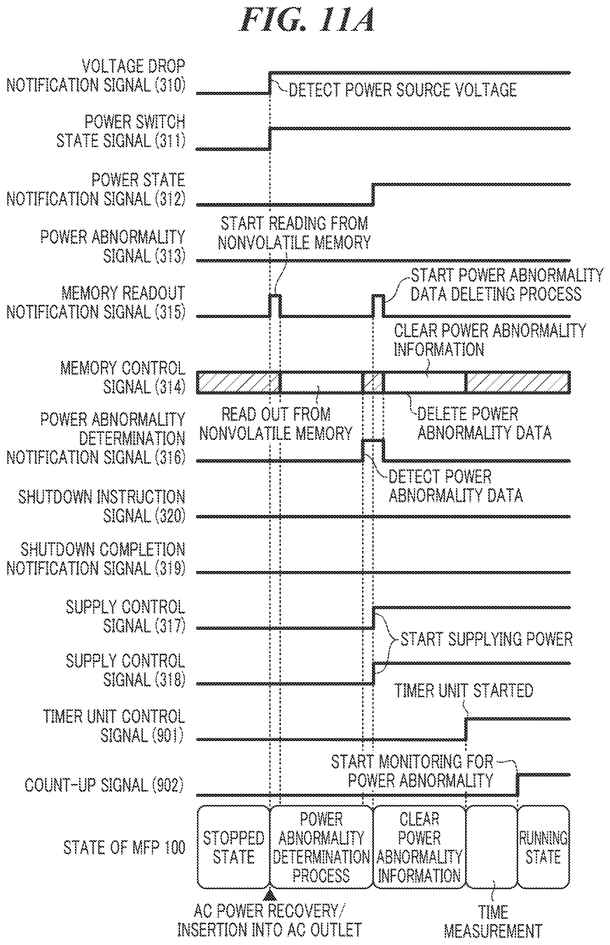

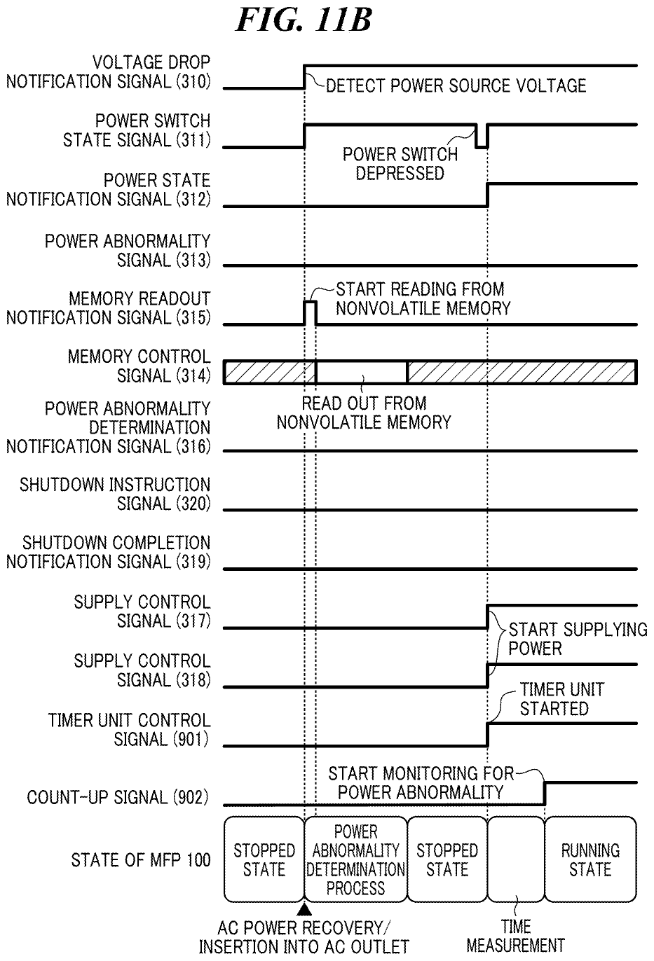

Referring to FIG. 10, the power control unit 901 carries out the processes in the steps S701 and S702. As a result of the determination in the step S702, in a case where the data that has been read is the power abnormality data, the power control unit 901 carries out the process in the step S703. FIG. 11A is a timing chart showing state transitions of respective signals when the MFP 100 reads out the power abnormality data and shifts from the stopped state to the running state. In the step S703, the power control unit 901 sends the supply control signals 317, 318 at a high level which give an instruction to start supplying power, to the power supply unit 106 and the controller power supply unit 203, respectively as shown in FIG. 11A. Then, the power control unit 901 carries out the process in the step S704. After that, the power control unit 901 causes the power state control unit 301 to send the timer unit control signal 903 to the timer unit 902 (step S1001), causing the timer unit 902 to start measuring elapsed time. When the above-mentioned predetermined time period has elapsed since the measurement was started, the timer unit 902 sends the count-up signal 904 to the power abnormality determination unit 300. Then, the power control unit 901 carries out the process in the step S707. After that, when the power abnormality determination unit 300 receives the count-up signal 904 from the timer unit 902 (YES in step S1002), the power control unit 901 carries out the processes in the step S709 and the subsequent steps.

As a result of the determination in the step S702, in a case where the data that has been read is not the power abnormality data, the power control unit 901 carries out the process in the step S705. When the power switch 104 has been depressed (YES in the step S705), the power control unit 901 carries out the process in the step S706. FIG. 11B is a timing chart showing state transitions of respective signals when the MFP 100 shifts from the stopped state to the running state in response to depression of the power switch 104. In the step S706, the power control unit 901 sends the supply control signals 317, 318 at a high level, which give an instruction to start supplying power, to the power supply unit 106 and the controller power supply unit 203, respectively as shown in FIG. 11B. Then, the power control unit 901 carries out the processes in the step S1001 and the subsequent steps.

In the embodiment described above, the determination as to whether an abnormal power state has occurred is started after the predetermined time period set in advance has elapsed since the starting process for the MFP 100 was started. The predetermined time period is longer than the time period that elapses until occurrence of an abnormal power state is detected after the starting process using remaining electric charge is started in a stopped state of the MFP 100. This prevents a drop in the voltage of the power source unit 103 from being detected when the user depresses the power switch 104 by mistake in the state where the MFP 100 is in a stopped state and electric charge still remains. As a result, unintended power abnormality data arising from remaining electric charge is prevented from being written.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-226634, filed Dec. 3, 2018, which is hereby incorporated by reference herein in its entirety.

What is claimed is:

1. An information processing apparatus comprising:
a processor;
a power supply device configured to supply power to at least the processor;
a nonvolatile memory configured to store information indicating that an output voltage of the power supply device has become equal to or lower than a threshold value;
a power controller configured to control power such that power is supplied from the power supply device to the processor in accordance with an operation on a power switch received in a state where no power was supplied to the processor, and control power such that power is supplied from the power supply device to the processor in accordance with the information stored in the nonvolatile memory; and
a memory controller configured to enable writing of the information into the nonvolatile memory in accordance with input of a predetermined signal output from the processor to which the power is supplied.

2. The information processing apparatus according to claim 1, further comprising:
a detecting part configured to detect an abnormality of the power supply device based on at least the information indicating that the output voltage of the power supply device has become equal to or lower than the threshold value,
wherein the detecting part starts monitoring for detecting an abnormality of the power supply device, after the processor is started and a software module to be executed by the processor is started.

3. The information processing apparatus according to claim 1, further comprising:
a detecting part configured to detect an abnormality of the power supply device based on at least the information indicating that the output voltage of the power supply device has become equal to or lower than the threshold value; and
a timer configured to measure a time period that has elapsed after a starting process for the information processing apparatus was started,
wherein the detecting part starts monitoring for detecting an abnormality of the power supply device after a predetermined time period set in advance has elapsed after the starting process for the information processing apparatus was started.

4. The information processing apparatus according to claim 3, wherein the predetermined time period is longer than at least a time period that elapses until an abnormality of the power supply device is detected after the starting process for the information processing apparatus is started using electric charge remained when supply of power from the power supply device was stopped.

5. The information processing apparatus according to claim 1, wherein:
the power switch is configured to receive instructions to start and stop the information processing apparatus, and
the memory controller does not write the information into the nonvolatile memory until the instruction to start the information processing apparatus is received after the instruction to stop the information processing apparatus is received.

6. The information processing apparatus according to claim 1, wherein the power switch does not physically hold a state of indicating that the information processing apparatus is running or stopped.

7. A control method for an information processing apparatus that has a processor, a power supply device that supplies power to at least the processor, and a nonvolatile memory that stores information indicating that an output voltage of the power supply device has become equal to or lower than a threshold value, the control method comprising:
supplying power from the power supply device to the processor in accordance with at least an operation on a power switch and the information stored in the nonvolatile memory; and
enabling writing of the information into the nonvolatile memory in accordance with input of a predetermined signal output from the processor to which the power is supplied.

8. The control method according to claim 7, further comprising:
detecting an abnormality of the power supply device based on at least the information indicating that the output voltage of the power supply device has become equal to or lower than the threshold value, and
starting monitoring for detecting an abnormality of the power supply device, after the processor is started and a software module to be executed by the processor is started.

9. The control method according to claim 7, wherein
the information processing apparatus further has a timer configured to measure a time period that has elapsed after a starting process for the information processing apparatus was started, and
the control method further comprises:
detecting an abnormality of the power supply device based on at least the information indicating that the output voltage of the power supply device has become equal to or lower than the threshold value; and
starting monitoring for detecting an abnormality of the power supply device after a predetermined time period set in advance has elapsed after the starting process for the information processing apparatus was started.

10. The control method according to claim 9, wherein the predetermined time period is longer than at least a time period that elapses until an abnormality of the power supply device is detected after the starting process for the information processing apparatus is started using electric charge remained when supply of power from the power supply device was stopped.

11. The control method according to claim 7, wherein
the power switch is configured to receive instructions to start and stop the information processing apparatus, and
the information is not written into the nonvolatile memory until the instruction to start the information processing apparatus is received after the instruction to stop the information processing apparatus is received.

12. The control method according to claim 7, wherein the power switch does not physically hold a state of indicating that the information processing apparatus is running or stopped.

13. A non-transitory computer-readable storage medium storing a program for causing a computer to execute a control method for an information processing apparatus that has a processor, a power supply device that supplies power to at least the processor, and a nonvolatile memory that stores information indicating that an output voltage of the power supply device has become equal to or lower than a threshold value,
the control method comprising:
supplying power from the power supply device to the processor in accordance with at least an operation on a power switch and the information stored in the nonvolatile memory; and
enabling writing of the information into the nonvolatile memory in accordance with input of a predetermined signal output from the processor to which the power is supplied.

14. The non-transitory computer-readable storage medium according to claim 13, wherein the control method further comprises:
detecting an abnormality of the power supply device based on at least the information indicating that the output voltage of the power supply device has become equal to or lower than the threshold value, and
starting monitoring for detecting an abnormality of the power supply device, after the processor is started and a software module to be executed by the processor is started.

15. The non-transitory computer-readable storage medium according to claim 13, wherein
the information processing apparatus further has a timer configured to measure a time period that has elapsed after a starting process for the information processing apparatus was started, and
the control method further comprises:
detecting an abnormality of the power supply device based on at least the information indicating that the output voltage of the power supply device has become equal to or lower than the threshold value; and
starting monitoring for detecting an abnormality of the power supply device after a predetermined time period set in advance has elapsed after the starting process for the information processing apparatus was started.

16. The non-transitory computer-readable storage medium according to claim 15, wherein the predetermined time period is longer than at least a time period that elapses until an abnormality of the power supply device is detected after the starting process for the information processing apparatus is started using electric charge remained when supply of power from the power supply device was stopped.

17. The non-transitory computer-readable storage medium according to claim 13, wherein
the power switch is configured to receive instructions to start and stop the information processing apparatus, and
the information is not written into the nonvolatile memory until the instruction to start the information processing apparatus is received after the instruction to stop the information processing apparatus is received.

18. The non-transitory computer-readable storage medium according to claim 13, wherein the power switch does not physically hold a state of indicating that the information processing apparatus is running or stopped.
